(19) United States
(12) Patent Application Publication
(10) Pub. No.: US 2006/0033659 A1
(43) Pub. Date: Feb. 16, 2006

(54) Mobile satcom antenna discrimination enhancement

(75) Inventor: Peter C. Strickland, Ottawa (CA)

Correspondence Address: MICHAEL J MEHRMAN;MEHRMAN LAW OFFICE PC, ONE PREMIER PLAZA, 5605 GLENRIDGE DRIVE SUITE 795, ATLANTA, GA, 30342, US

(73) Assignee: EMS Technologies Canada, Ltd.

(21) Appl. No.: 10/915,255

(22) Filed: Aug. 10, 2004

(51) Int. Cl. H01Q 3/22; H01Q 1/36

(52) U.S. Cl. 342/372; 342/377

(57) ABSTRACT

An antenna array especially for use on mobile platforms, which provides the spatial discrimination in selected directions required for such antennas. The shape of the radiation pattern of the antenna array is modified dynamically, such that the gain in the direction of other sources is sufficiently low to meet the desired or required spatial discrimination to avoid any significant interference with the other sources. The pattern is controlled by controlling the amplitude and/or the phase of one or more elements within or outside the antenna array. In this manner reduced gain or nulls can be directed at the potentially interfering sources, which are not being utilized by the antenna array for communications.

### TECHNICAL FIELD

The present invention is directed generally to phased-array antennas and more particularly to mobile platform antenna arrays with enhanced spatial discrimination in selected directions.

### BACKGROUND OF THE INVENTION

Communications from an antenna array on a mobile platform requires control of the antenna radiation pattern so that communication transmissions to and from the mobile platform do not interfere with communications to and from other sources and other mobile platforms, such as separate communications from another source with another mobile platform, such as a satellite. Generally, the radiation pattern or beam from the mobile platform is directed to a satellite of interest and the beam (pattern) shape of the antenna array is designed and/or directed such that interference with other satellites is sufficiently low. For example, the beam width of the pattern from the mobile platform antenna array can be smaller than the angular spacing between the satellites of interest to provide the required spatial discrimination from the next adjacent satellite, such that the interfering power transmitted to the adjacent satellite is sufficiently low.

Conventional phased-array antennas are widely utilized in aeronautical satellite communications. These arrays tend to be long and relatively wide in order to satisfy the spatial discrimination requirements for satellite communications and interference requirements. For example, an aircraft fuselage top-mounted phased antenna array is typically on the order of forty (40) centimeters (cm) wide and sixty (60) cm long to satisfy the Inmarsat high-gain antenna requirements. These antenna arrays utilize uniform lattices and quantified gradient phasing with relatively uniform gain in order to produce the required beam pattern directed to the satellite of interest.

When the mobile platform is an aircraft, the communications with the aeronautical satellites is especially challenging, since the aircraft can maneuver quickly and can cover large distances in a short time period. This requires that the beam shape be very agile to ensure that the regions of reduced gain in the beam pattern are directly appropriately to provide the required spatial discrimination to minimize interference with other satellites and sources. For example, it may be necessary to have a reduced gain in the beam pattern in the direction of specific satellites on the geosynchronous arc or in the direction of other sources. These satellites may share the same frequency band as the aircraft is utilizing for transmission and/or reception. It also may be necessary to reduce the pattern gain in the direction of LEO or MEO satellites. Similar gain reduction may be useful for improved spatial discrimination with other mobile platform antenna systems, such as utilized on ships, trains or vehicles, for example trucks and SUV's. The gain reduction may be utilized with non-satellite based antenna systems to provide desirable spatial discrimination as well.

Accordingly, it can be seen that a need exists for a phased array antenna especially for use on mobile platforms, such as aircraft, to provide the required spatial discrimination in selected directions. It also would be desirable to attain the desired spatial discrimination while reducing the physical size of the antenna array for use on the mobile platforms.

### SUMMARY OF THE INVENTION

The present invention is directed to an antenna array especially for use on mobile platforms, which provides the spatial discrimination in selected directions required for such antennas. The antenna array also can be designed in a structurally reduced physical size, which again is most desirable for use on mobile platforms, such as on an aircraft.

The shape of the radiation pattern of the antenna array is modified dynamically, such that the gain in the direction of other sources is sufficiently low to meet the desired or required spatial discrimination to avoid any significant interference with the other sources. The pattern is controlled by controlling the amplitude and/or the phase of one or more elements within or outside the antenna array. In this manner reduced gain or nulls can be directed at the potentially interfering sources, which are not being utilized by the antenna array for communications. This allows the array to be physically reduced in size, while still satisfying the required spatial discrimination requirements for the array utilization.

The spatial discrimination can also be achieved by the utilization of one or more additional elements, not otherwise part of the array, which can be configured outside of the array to produce the desired gain reduction in the desired or necessary angular/spatial regions. These additional elements can be utilized in place of or in conjunction with controlling the amplitude and/or the phase of one or more elements in the array.

The gain can be low during transmit or receive modes or in both modes. The gain can be reduced or minimized in the direction of one or more satellites or one or more angular regions. The gain can be reduced in the direction of sources on the ground, on buildings or other mobile platforms, such as aircraft, trains and ships.

Generally described, the invention may be deployed as a phased array antenna including a plurality of commonly excited antenna elements in which each antenna element has at least one associated phase control device and at least one associated amplitude control device. The antenna also includes a position locator that determines the direction from the antenna toward desired nulls and desired beams, and a controller that determines a desired radiation pattern including high-gain beams in the desired beam directions and low-gain nulls in the desired null directions. The controller also determines phase and amplitude control signals for causing the antenna elements to produce or approximate the desired radiation pattern. The antenna also includes a signal generator that generates and applies the phase and amplitude control signals to the phase and amplitude control devices.

For a vehicle-mounted antenna, the controller continually updates the control signals at a sufficiently high clock rate to dynamically maintain spatial discrimination between the desired nulls and the desired beams as the antenna moves. For example, the desires antenna pattern may include first desired beam direction toward a first satellite and a first desired null direction toward a second satellite. The desired antenna pattern may also a second desired beam direction toward a receiver carried on a vehicle. Of course, additional desired beam and null directions may be included to support the needs of a particular application.

In addition, the desired antenna pattern is typically generated by producing an array radiation pattern including a high-gain beam in a desired beam direction and an interfering radiation pattern including an interfering beam in a desired null direction which combines with the array radiation pattern to reduce gain in the null direction. Although the array radiation pattern and the interfering radiation pattern may both be produced by a regular phased array, it may be advantageous for some applications to generate the high-gain beams wit a regular phased array, while generating the interfering beams with one or more outrigger antenna elements located outside the outside the regular phased array. In particular, the antenna elements of the regular phased array may be mounted on a common backplane, whereas the outrigger antenna elements may be separately mounted.

As a specific example, the desired radiation pattern may be derived as a discrete least mean square approximation of a theoretic radiation pattern. In addition, the desired radiation pattern may include a fixed amplitude distribution and phase gradient.

Other features and advantages of the present invention will be readily appreciated upon review of the following detailed description when taken in conjunction with the accompanying drawing figures.

### BRIEF DESCRIPTION OF THE DRAWINGS

FIG. 1 is a diagrammatic illustration of utilization of the antenna array of the present invention in a satellite environment.

FIG. 2 is a diagrammatic illustration of an embodiment of the present invention utilizing only elements within the grid of the antenna array.

FIG. 3 is a diagrammatic illustration of another embodiment of the present invention utilizing an element outside the grid in conjunction with the elements within the grid of the antenna array.

FIG. 4 is a diagrammatic illustration of a further embodiment of the present invention utilizing a plurality of elements outside the grid in conjunction with the elements within the grid of the antenna array.

FIG. 5 is a functional block diagram of an antenna system configured to implement dynamic special discrimination between desired nulls and desired beams.

FIG. 6 is a logic flow diagram for operating the antenna system of FIG. 5.

### DETAILED DESCRIPTION OF THE PREFERRED EMBODIMENTS

The present invention is specifically designed to serve as a mobile satellite communication antenna system carried by an aircraft. However, the dynamic spatial discrimination capability of the invention has general applicability to any type of communication system that can benefit from dynamically steering beams and nulls to maintain communication with desired targets while avoiding interference with or detection by other targets. As such, the present invention may also be deployed in other types of communication systems with independently steered beams and nulls, such as a ground-based antenna systems for tracking moving vehicles, a satellite-based antenna systems for tracking moving vehicles, a missile defense system, a military defense system for assets such as ships, tanks, building, bases, and so forth. Moreover, the dynamic spatial discrimination capability of the invention might also be deployed on target recognition ordinance systems, such as cruise missiles, unmanned aerial vehicles, smart bombs, and the like. Other applications for the technology will become apparent to those skilled in the art once the advantages and operational details of the invention are understood. Further, the invention may also be deployed for communication systems operating in transmission media other than free space, such as a sonar system.

The embodiments of the present invention rely in part on well known technologies, such as Global Positioning System (GPS) technology, radar systems, and multi-beam antenna systems. In particular, the fundamentals of independently steered multi-beam antenna systems are described in commonly-owned “Beamformer For Multi-Beam Receive Antenna,” U.S. Pat. No. [application Ser. No. 10/290,996] and “Beamformer For Multi-Beam Receive Antenna,” U.S. Pat. No. [application Ser. No. 10/290,985], which are incorporated herein by reference.

The dynamic spatial discrimination capability of the invention may be implemented by a regular phased array (i.e., a linear or grid array including regularly spaced antenna elements) mounted to a common backplane. However, new and retrofit applications may be deployed by including one or more outrigger antenna elements mounted separately from the regular phased array. A typical regular phased array for implementing the present invention operates at a carrier frequency in the MHz or GHz range and includes antenna element arranged in a linear or grid array spaced approximately one-half the free-space carrier wavelength. However, antenna systems operating at different carrier frequencies and having different antenna array configurations may also deployed using the technology of the present invention.

It should also be appreciated that the invention may be deployed in a receive-only, a broadcast-only, or a two-way communication system. For this reason, the terms “beams,” “radiation patterns” and the like refer to both emission and reception antenna patterns. Similarly, the invention may be deployed in communication systems with encoded data, such as a telephone system, or in communication systems without encoded data, such as a radar system. Of course, any type of data encoding and multiplexing scheme may be employed in connection with the communication system.

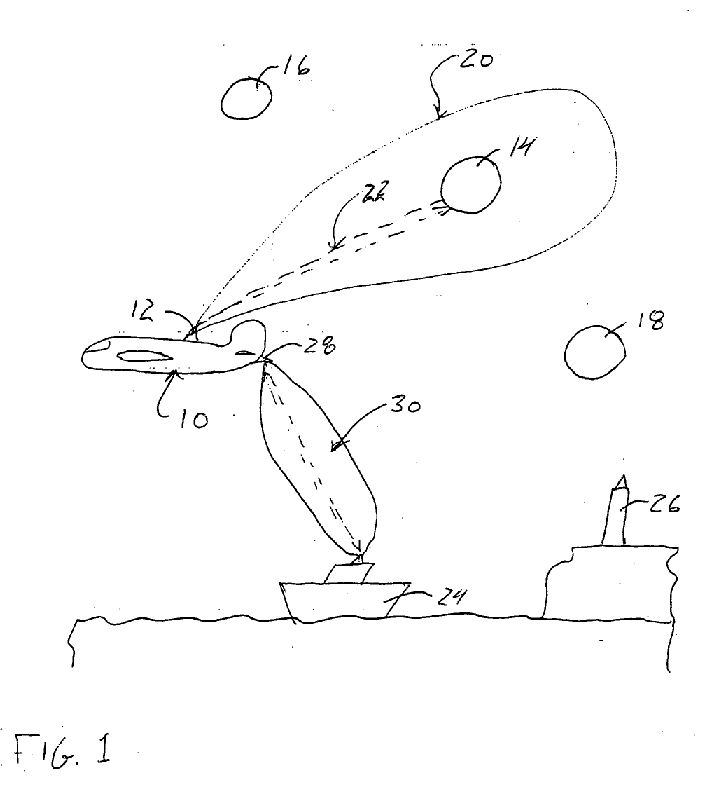

Referring now to the drawings, in which like numerals refer to similar elements throughout the several figure, FIG. 1 shows a specific embodiment of the invention including an aircraft 10 that includes a first antenna array 12. Specific examples of the antenna array 12 are disclosed in detail in FIGS. 2-4. The antenna array 12 is illustrated as communicating with a satellite 14, with two adjacent non-communicating satellites 16 and 18, with which the array 12 must not interfere. The antenna array 12 generates a beam or, more particularly, a radiation pattern 20, which may be a transmit, receive, or two-way radiation pattern. The pattern 20 theoretically is in the form of a beam of a narrow width aimed directly at the satellite 14, illustrated by the dashed lines 22. In actuality, the pattern 20 is much broader than the beam illustrated and can include side lobes that can produce interference with other radiation sources, such as the satellites 16 and 18, a ship 24 or a land tower antenna source 26.

The aircraft 10 can include a second beam and/or second antenna array 28 which is utilized to communicate with the ship 24, as illustrated by a beam radiation pattern 30, or with the tower antenna 26, such as an air traffic control, cellular, or other type of communication tower, or the other satellites 16 and 18. The ship 24 also could communicate with the aircraft 10 or with one or more of the satellites 14, 16 or 18 or with the tower 26. The beam pattern 30 could interfere with one or more of the other sources 14, 16, 18 or 26. It therefore is important that the beam patterns 20 and 30 have the required spatial discrimination in the selected directions. The beam patterns 20 and 30 also preferably are steered in a conventional manner to insure that the mobile platforms, such as the aircraft 10 and the ship 24 maintain good communications as the platforms move relative to the satellites 14, 16 or 18 or with one another. This further requires that the spatial discrimination be dynamic, since the direction of the source will change and hence the null must be steered accordingly.

A first embodiment of the antenna array of the present invention is designated generally by the reference numeral 40 in FIG. 2. The array includes four (4) substantially identical antenna elements 42, 44, 46 and 48 forming a regular array grid 50. Although only four antenna elements are illustrated, the grid 50 can include as many as desired or required for the specific application. The antenna elements 42, 44, 46 and 48 are coupled to respective phase shifters, 52, 54, 56 and 58 to control the relative phases of the antenna elements 42, 44, 46 and 48. The antenna elements 42, 44, 46 and 48 then further are coupled to respective attenuators 60, 62, 64 and 66 to control the relative excitation amplitude of each of the antenna elements 42, 44, 46 and 48.

A common port 68 functions as the RF input to and output from the antenna array 40. The antenna elements 42, 44, 46 and 48 are coupled to the port 68 by respective lines 70, 72, 74 and 76. The antenna elements 42, 44, 46 and 48 are commonly mounted on a backplane supporting the main array grid 50. In conjunction with the respective phase shifters 52, 54, 56 and 58 and the respective attenuators 60, 62, 64 and 66; the antenna elements 42, 44, 46 and 48 individually are excited to produce the full composite radiation pattern with regions of reduced gain as desired for the specific application and location of the array 40. The pattern also is dynamically adjusted to direct or steer the null or nulls of the resulting pattern as the mobile platform moves with respect to the other sources.

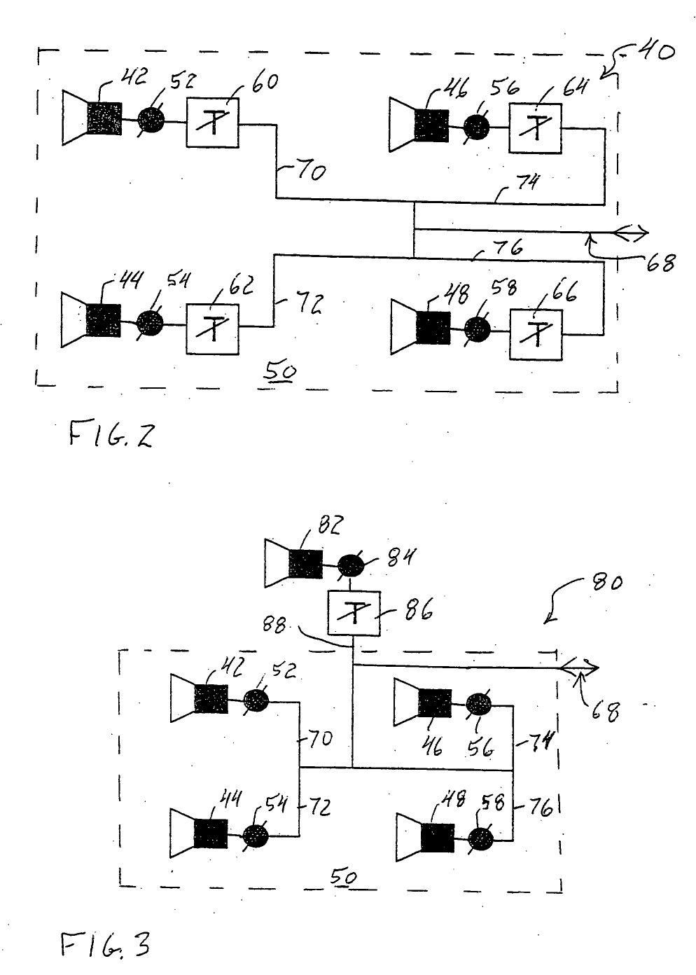

In the array 40, all of the antenna elements 42, 44, 46 and 48 are located within the commonly-mounted grid 50 formed by the four elements. In contrast, a second embodiment of the antenna array of the present invention is designated generally by the reference numeral 80 in FIG. 3. In the array 80, the antenna elements 42, 44, 46 and 48 again are located within the commonly-mounted grid 50 formed by the four elements and again include at least the respective phase shifters 52, 54, 56 and 58. The array 80 also can include the respective attenuators 60, 62, 64 and 66. Additionally, the array 80 includes an additional outrigger antenna element 82, which is typically mounted separately from the main grid of antenna elements. The outrigger antenna element 82 is coupled to a phase shifter 84 and then to an attenuator 86 and then to the common input 68 by a line 88. The outrigger element 82 is excited and controlled to produce the desired spatial discrimination or dynamic directed null for the array 80.

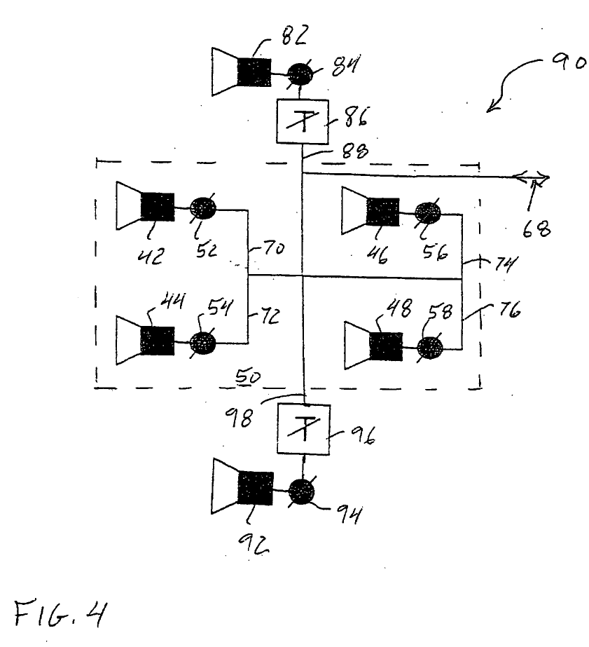

A further embodiment of the antenna array of the present invention is designated generally by the reference numeral 90 in FIG. 4. The array 90 is substantially identical in structure and operation with the array 80, but further includes another outrigger antenna element 92, coupled to a phase shifter 94 and then to an attenuator 96 and then to the common input 68 by a line 98. The additional element 92 is excited and controlled to produce the desired spatial discrimination or dynamic directed null for the array 90 in conjunction with the element 82 and the elements of the grid 50. The elements 42, 44, 46 and 48 again are located within the regular grid 50 formed by the four elements and again include at least the respective phase shifters 52, 54, 56 and 58, but again can include the respective attenuators 60, 62, 64 and 66.

Inmarsat high-gain aeronautical antennas can be made physically smaller than the current array designs, through the utilization of the enhanced discrimination techniques and structures of the present invention. Current aircraft fuselage-mounted phased antenna arrays, which satisfy the SDM requirements for high-gain systems are conventionally quite large both in length and width of the arrays. The current :array structures generally are sufficiently thin for aircraft applications. By utilization of the techniques of the invention, the amplitude and phase of one or more of the array elements 42, 44, 46 and 48 or the additional elements 82 and 92 or combinations thereof are controlled to reduce the gain in one or more selected directions relative to that achieved by the current array designs.

In particular, nulls or reduced gains can be dynamically directed at other sources, such as one or more of the satellites 14, 16 and 18, along the geosynchronous arc that are not being utilized for communications by the antenna of the invention. This permits the antenna arrays 40, 80 and 90 to have a smaller width and/or length than the current arrays, while still achieving the required antenna discrimination patterns. For example, narrow antenna arrays 80 and 90 can be utilized along with one or more outrigger elements 82 and 92 displaced from the array grid 50. The outrigger element(s) 82 and 92 are utilized to produce one or more regions of reduced gain, or nulls, to improve the overall antenna discrimination against adjacent satellites 16 and 18 as illustrated in FIG. 1. The techniques of the invention also can be utilized for null steering in Inmarsat medium and low-gain antenna arrays.

For example, the invention can be implemented in any phased antenna array by controlling the amplitude and/or phase on one or more of the antenna elements 42, 44, 46 and 48. Utilizing the antenna array 80, the single outrigger element 82 can be utilized to dynamically direct the null in the desired direction. The phases of the elements 42, 44, 46 and 48 then are adjusted to produce high-gain, the beam 20 in FIG. 1, directed at the satellite 14 of interest. The resulting radiation pattern will have a beam peak in the desired direction of the satellite 14, but will also include some gain in the direction of the next satellite 16 on the geostationary arc, which satellite may share the frequency band of interest being utilized by the array 80. The additional element 82 then is combined with the pattern produced by the array elements 42, 44, 46 and 48, with the phase and amplitude respectively adjusted the by the phase shifter 84 and the attenuator 86. By optimally setting and continually adjusting the phase and amplitude of the element 82, the overall antenna system 80 will have a very low-gain or null dynamically directed at the next satellite 16.

Where it is desired to produce two nulls in the pattern 20, then the array 90 can be utilized to reduce the gain in the pattern 20 in both the direction of the satellites 16 and 18. Also, although the elements 82 and 92 are illustrated outside the grid 50, they also could be located within the grid 50. Also, the invention contemplates using only the elements 42, 44, 46 and 48 in the array 40 to produce the desired null or nulls directed at the satellites 16 and/or 18 or any other desired sources. The phases and amplitudes of each of the elements 42, 44, 46 and 48 are individually set to obtain the desired reduced gain patterns and to dynamically direct the nulls.

A variety of different algorithms can be utilized by one of ordinary skill in the art to determine the excitations of the elements 42, 44, 46 and 48, and/or the elements 82 and 92 to produce the desired and/or required high and low-gain or null patterns. For example, a discrete least mean square technique can be utilized to define the desired pattern and null regions at an arbitrary number of points in space. If the number of points selected is lower than the number of antenna elements in the array, then the pattern will exactly match that defined, except for errors made by hardware quantization and other related effects. If the number of desired pattern points exceeds the number of antenna elements in the array, then the pattern achieved by the array will be the best least mean square error fit. One skilled in the art can utilize other algorithms. For example, the antenna array can be excited in a conventional manner with a fixed amplitude distribution and a phase gradient to produce the main beam 20 in the desired direction. The amplitude and phase of the pattern in the “interfering” direction(s) then can be computed and the amplitude and phase distribution required to cancel or reduce the gain in this direction(s) can be computed and added to the array excitation of the elements 42, 44, 46 and 48. Alternately, the cancellation or null distribution can be produced by the additional elements 82 and/or 92 outside or at the edge of the grid 50.

While the invention has been described in several preferred embodiments, those skilled in the art will readily appreciate that many modifications, additions and deletions can be made to the invention as described and disclosed without departing from the spirit and scope of the present invention. Although only the elements 42, 44, 46 and 48 and the additional elements 82 and 92 have been illustrated, other elements can be added as desired.

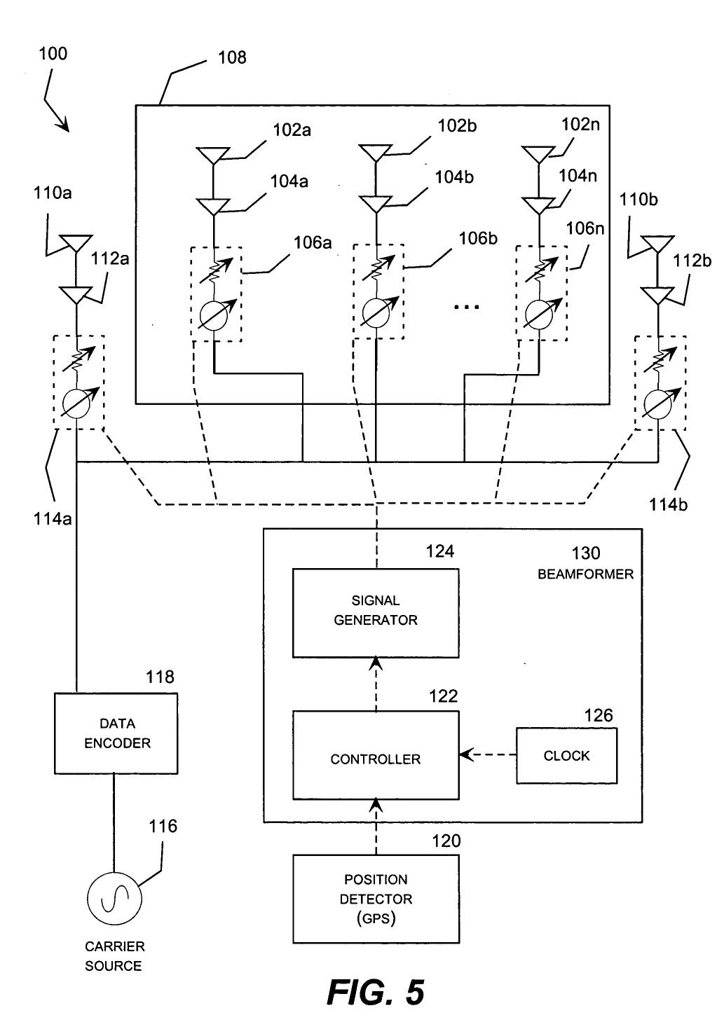

FIG. 5 is a functional block diagram of an antenna 100 configured to implement dynamic special discrimination between desired nulls and desired beams in accordance with the present invention. The antenna system 100 includes a number of similar antenna elements 102a-n arranged in a linear or grid array. Typically, the spacing between the antenna elements is uniform, forming a regular array, with a spacing of one-half the free-space wavelength at the carrier frequency. Each of the antenna elements 102a-n is connected to a respective low-noise amplifier 102a-n and a phase and gain control device 106a-n in a transmission media circuit. Of course, the phase and gain control devices may be physically integrated or separate devices, and each antenna element may include multiple phase and gain control devices. In addition, a group of antenna element may be commonly controlled by a single phase and gain control device. The regular grid of devices antenna elements 102a-n is preferably mounted on a common backplane 108 which supports the transmission media conductors and other devices, such as power dividers, noise filters, and other desired components, as is well known in the field of antenna design.

This particular antenna system 100 also includes a pair of outrigger antenna elements 110a-b, which are mounted separately from the common backplane 108 supporting the regular array of antenna elements 102a-n. Nevertheless, is should be appreciated that the outrigger antenna elements 110a-b could be mounted on the common backplane 108, and that outrigger antenna elements located outside the regular array are not required to implement the present invention. In addition, the number of outrigger antenna elements shown in FIG. 5 is merely illustrative. Each of the outrigger antenna elements 110a-b is connected to a respective low-noise amplifier 112a-b and a phase and gain control device 114a-b in a transmission media circuit.

To generate broadcast signals, the antenna element are commonly fed by a carrier source 116, which generates electromagnetic energy at the desired carrier frequency. For communication applications involving encoded data, such as a wireless telephone application, the antenna system also includes a data encoded 118. This element is not necessary for an application that does not transmit encoded data, such as a radar application. Those skilled in the art will appreciate the additional elements of the transmitter and/or receiver are necessarily present but not illustrated to avoid cluttering the figure.

To implement the dynamic spatial discrimination feature of the present invention, the antenna system 100 includes a position detector 120, which monitors the desired beam and null directions with respect to the antenna system. Depending on the application, the antenna system may itself be stationary or moving, and the targets corresponding to the desired beam and null directions may be stationary or moving. For this reason, the position detector 120 relies on fixed coordinate locations as well as GPS and other dynamic positioning data as required. The position detector 120 may also rely on position information from other sources, such as radar, overhead data channel, or any other suitable source. Whatever the specific configuration may be, the position detector 120 keeps track of the desired beam and null directions with respect to the antenna system as the antenna system and the null and beam targets move with respect to each other.

A controller 122 receives the position information from the position detector 120 and determines a desired radiation pattern for the antenna including high-gain beams in the desired beam directions and low-gain nulls in the desired null directions. The controller 122 then determines control signals required to cause the antenna system 100 to produce or approximate the desired radiation pattern. For example, the control signals may be configured to cause the regular array of antenna elements 102a-n to produce high-gain beams in the desired beam directions, while simultaneously causing the outrigger antenna elements 110a-n to produce interfering beams that partially cancel the radiation pattern produced by the regular array, thereby reducing the gain of the overall antenna pattern in the desired null directions.

The antenna system 100 also includes a signal generator 124 that converts the desired control signals into the proper format and applies them to the phase and gain control devices 106a-n and 114a-b. For example, the phase and gain control may be conventional analog phase shifters and attenuators, or they may be digital equivalents, or a combination of digital and analog equipment, as is well known in the field of antenna design. Whatever the specific configuration may be, the controller 122 continually updates the control signals at a sufficiently fast clock rate, typically in the kHz range, to maintain spatial communication discrimination between the desired beams and the desired nulls as the antenna system and the beam and null targets move with respect to each other. For descriptive convenience, the signal generator 124, controller 122, and control clock 126 may be considered a unit referred to as a beamformer 130, which may be deployed on a common PC board, microprocessor, or application-specific integrated circuit (ASIC).

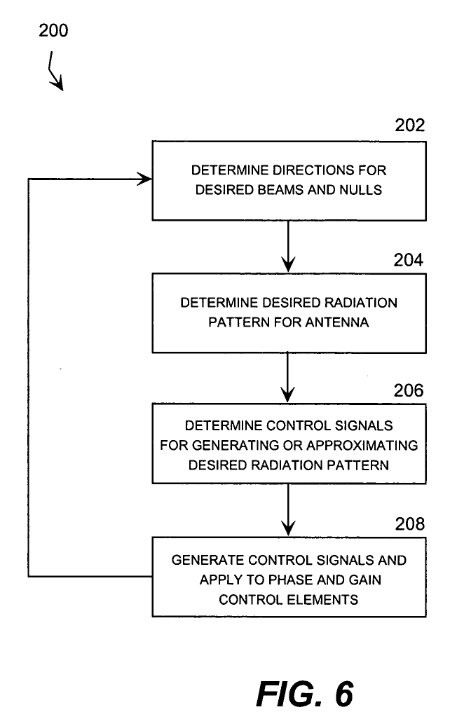

FIG. 6 is a logic flow diagram illustrating a routine 200 for operating the antenna system 100 shown in FIG. 5. At step 202, the position detector 120 determines the desired beam and null directions and passes this information to the controller 122. Step 202 is followed by step 204, in which the controller 122 determines the desired antenna radiation pattern including high-gain beams in desired beam directions and low-gain nulls in desired null directions. Step 204 is followed by step 206, in which the controller 122 determines control signals required to cause the antenna elements to generate or approximate the desired radiation pattern and passes these control signals to the signal generator 124. Step 206 is followed by step 208, in which the signal generator 124 formats the control signals properly and delivers them to the phase and gain control phase and gain control devices 106a-n and 114a-b. This causes the antenna elements 102a-n and 110a-b to emit or receive the desired radiation pattern. Routine 200 then loops from step 208 back to step 202, and the process repeats at a sufficiently high clock rate to maintain spatial communication discrimination between the desired beams and the desired nulls as the antenna system 100 and the beam and null targets move with respect to each other.

In view of the foregoing, it will be appreciated that present invention provides an improved system for maintaining spatial discrimination between desired beams and nulls with a phased array antenna system. It should be understood that the foregoing relates only to the exemplary embodiments of the present invention, and that numerous changes may be made therein without departing from the spirit and scope of the invention as defined by the following claims.

1. A phased array antenna including a plurality of commonly excited antenna elements, each antenna element having at least one associated phase control device and at least one associated amplitude control device, comprising:
a position locator configured to determine the direction from the antenna toward desired nulls and desired beams;
a controller configured to determine a desired radiation pattern including high-gain beams in the desired beam directions and low-gain nulls in the desired null directions;
the controller further configured to determine phase and amplitude control signals for causing the antenna elements to produce or approximate the desired radiation pattern; and
a signal generator configured to generate and apply the phase and amplitude control signals to the phase and amplitude control devices.

2. The antenna of claim 1, wherein the controller continually updates the control signals at a sufficiently high clock rate to dynamically maintain spatial discrimination between the desired nulls and the desired beams as the antenna moves with a vehicle.

3. The antenna of claim 1, wherein the desired radiation pattern includes a first desired beam direction toward a first satellite and a first desired null direction toward a second satellite.

4. The antenna of claim 3, wherein the desired radiation pattern includes a second desired beam direction toward a receiver carried on a vehicle.

5. The antenna of claim 1, wherein the desired radiation pattern comprises an array radiation pattern comprising high-gain beams in the desired beam directions and an interfering radiation pattern comprising interfering beams in the desired null directions that combine with the array radiation pattern to reduce gain in the null directions.

6. The antenna of claim 5, further comprising a regular phased array producing the high-gain beams and one or more outrigger antenna elements outside the outside the regular phased array producing the interfering beams.

7. The antenna of claim 6, further comprising a common backplane supporting the antenna elements of the regular phased array and separately mounted outrigger antenna elements.

8. The antenna of claim 1, wherein the antenna dynamically maintains spatial discrimination between the desired nulls and the desired beams in a receive mode.

9. The antenna of claim 1, wherein the antenna dynamically maintains spatial discrimination between the desired nulls and the desired beams in both transmit and receive modes.

10. The antenna of claim 1, wherein the desired radiation pattern comprises a discrete least mean square approximation of a theoretic radiation pattern.

11. The antenna of claim 1, wherein the desired radiation pattern comprises a fixed amplitude distribution and phase gradient.

12. A beamformer for a phased array antenna including a plurality of commonly excited antenna elements, each antenna element having at least one associated phase control device and at least one associated amplitude control device, comprising:
a controller configured to continually determine phase and amplitude control signals for causing the antenna elements to produce a desired radiation pattern at a sufficiently high clock rate to dynamically maintain spatial discrimination between the desired nulls and the desired beams as the antenna moves with a vehicle; and
a signal generator configured to generate and apply the phase and amplitude control signals to the phase and amplitude control devices.

13. In or for a phased array antenna including a plurality of commonly excited antenna elements, an improvement comprising a beamformer operable for continually generating a desired radiation pattern at a sufficiently high clock rate to dynamically maintain spatial discrimination between the desired nulls and the desired beams as the antenna moves with a vehicle.

14. The phased array antenna of claim 13, further comprising a commonly mounted regular phased array producing the array radiation pattern and one or more separately mounted outrigger elements producing the interfering radiation pattern.

15. A method for operating a phased array antenna including a plurality of commonly excited antenna elements, each antenna element having at least one associated phase control device and at least one associated amplitude control device, comprising the steps of:
(a) determining desired beam directions and desired null directions with respect to the antenna;
(b) determining a desired radiation pattern including high-gain beams in the desired beam directions and low-gain nulls in the desired null directions;
(c) determining phase and amplitude control signals for causing the antenna elements to produce or approximate the desired radiation pattern;
(d) applying the phase and attenuator control signals to the phase and attenuator control device; and
(e) continually repeating steps (a) through (d) to at a sufficiently high clock rate to dynamically maintain spatial discrimination between the desired nulls and the desired beams while the antenna array moves with respect to the desired beams and desired nulls.

16. The method of claim 15, wherein the step of determining desired beam directions and desired null directions with respect to the antenna comprises the steps of:
determining a first desired beam direction toward a first satellite; and
determining a first desired null direction toward a second satellite.

17. The method of claim 16, wherein the step of determining desired beam directions and desired null directions with respect to the antenna comprises the step of determining a second desired beam direction toward a receiver carried on a vehicle.

18. The method of claim 15, wherein the step of determining phase and amplitude control signals for causing the antenna elements to produce or approximate the desired radiation pattern comprises the steps of:
determining an array radiation pattern comprising high-gain beams in the desired beam directions; and
determining an interfering radiation pattern comprising interfering beams in the desired null directions that combine with the array radiation pattern to reduce gain in the null directions.

19. The method of claim 18, further comprising the steps of:
producing the high-gain beams at a regular phased array; and
producing the interfering beams at one or more outrigger antenna elements outside the outside the regular phased array.

20. The method of claim 19, wherein the antenna elements of the regular phased array are mounted on an common backplane, and the outrigger antenna elements are not mounted on the common backplane.

21. The method of claim 20, wherein the antenna dynamically maintains spatial discrimination between the desired nulls and the desired beams a transmit mode.

22. The method of claim 20, wherein the antenna dynamically maintains spatial discrimination between the desired nulls and the desired beams in a receive mode.

23. The method of claim 22, wherein the step of determining phase and amplitude control signals for causing the antenna elements to produce or approximate the desired radiation pattern comprises the step of determining a discrete least mean square approximation of the desired radiation pattern.

24. The method of claim 22, wherein the step of the desired radiation pattern comprises a fixed amplitude distribution and phase gradient.
